(19) United States
(12) Patent Application Publication
(10) Pub. No.: US 2004/0196494 A1
(43) Pub. Date: Oct. 7, 2004

(54) Method for determining the format type of a print data stream

(76) Inventor: William Binder, Oakland, MI (US)

Correspondence Address: HARNESS, DICKEY & PIERCE, P.L.C., P.O. BOX 828, BLOOMFIELD HILLS, MI, 48303, US

(21) Appl. No.: 10/406,363

(22) Filed: Apr. 3, 2003

(51) Int. Cl. G06F 3/12; H04N 1/41; G06F 9/30; G06F 15/00

(52) U.S. Cl. 358/1.15; 358/426.02; 358/426.12; 709/231

(57) ABSTRACT

A method is for determining a format type of a print data stream having one of a plurality of known data stream formats. The method includes: presenting a print data stream having a plurality of numeric values encoding data formulated in an unknown data stream format; determining an encoding format for the numeric values of the print data stream; and analyzing the print data stream in relation to a plurality of known data stream formats, thereby determining a format type for the print data stream.

### FIELD OF THE INVENTION

The present invention relates generally to systems that archive and store information and more particularly to a method for determining a format type for a print data stream.

### BACKGROUND OF THE INVENTION

As the amount of information produced by businesses has increased, the need to store printed information within electronic retrieval systems has become a necessity. These retrieval systems and other information archives first classify and store the information and then provide an easy retrieval mechanism to view the information via a terminal, personal computer, or internet browser.

In order to archive and later retrieve this information, data that is normally sent to a printer is also sent to archive and retrieval systems. This data is known as a print data stream and contains all the information a printer requires to properly format the data on a page of paper. An archive and retrieval system also uses this format information to properly format the data for presentation on a screen during retrieval of the data, as well as for data extraction, data classification, and data storage.

There are generally three elements of a print data stream that are considered to be its format. These include the character encoding set, the record separation, and the carriage controls. The character encoding set is a digital representation of the text. The two most common character encoding sets for print data streams are the American Standard Code for Information Interchange (ASCII) and the Extended Binary Coded Decimal Interchange Code (EBCDIC). Record separation is a method the format uses to separate or delimit records or print lines within the print data stream. There are three basic schemes used by different formats for record separation including fixed length records wherein all the records in a stream have the same character length, record delimiters wherein special characters different from normal text are used to mark the end of a record, and byte or word separation wherein a byte or word at the beginning of each record stores the length of the record. Finally, carriage controls are instructions embedded within the data stream that tell the printer how to move vertically on the page.

An archive and retrieval system requires the print data stream format to be pre-identified before the data can be processed by the system. If the archive and retrieval system is limited to using only one format type, pre-identification of the format type is relatively simple. However, there are a vast number of print data stream formats used throughout industry. In many cases, print data streams from separate computer systems, each having a different format type, might all need to be processed by a single archive and retrieval system. The archive and retrieval system must be able to determine which format type should be used with each set of print data streams from each computer system. Typically, this pre-identification is a manual task that requires extensive time and effort, and does not allow for the inclusion of new, ad-hoc print data streams. Therefore, it is desirable to provide an automated method for determining the format type of a print data stream.

### SUMMARY OF THE INVENTION

In accordance with the present invention, a method is provided for determining a format type of a print data stream having one of a plurality of known data stream formats. The method includes: presenting a print data stream having a plurality of numeric values that encodes data formulated in an unknown data stream format; determining an encoding format for the numeric values of the print data stream; and analyzing the print data stream in relation to a plurality of known data stream formats, thereby determining a format type for the print data stream.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a diagram depicting a method for determining the format type of a print data stream according to the principles of the present invention;

FIG. 2 is a block diagram depicting a computer-implemented system for determining the format type of a print data stream according to the principles of the present invention; and

FIG. 3 is a flow chart illustrating an exemplary embodiment of the method for determining the format type of a print data stream according to the principles of the present invention.

### DETAILED DESCRIPTION OF THE PREFERRED EMBODIMENTS

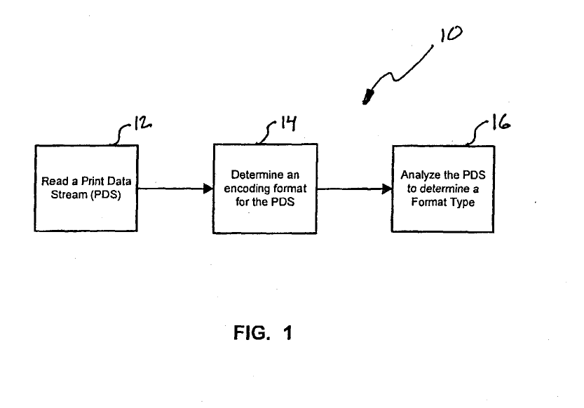

A method for determining the format type of a print data stream according to the principles of the present invention is indicated generally by reference numeral 10 in FIG. 1. A print data stream is comprised of a plurality of numeric values encoding data that is intended to be printed on paper and/or output to a digital media. In addition, the print data stream is typically formulated in accordance with a well-defined format. For instance, the print data stream may include printer control codes or other types of formatting codes as is well known in the art. While the following description is provided with reference to print data streams, it is readily understood that the broader aspects of the present invention may be readily applied to other types of structured documents that are available in digital form.

To determine format type, the print data stream is initially read as shown at step 12. Next, the encoding format of the print data stream is determined at step 14. Lastly, the print data stream is analyzed at step 16 in relation to a plurality of known data stream formats, thereby determining a format type for the print data stream.

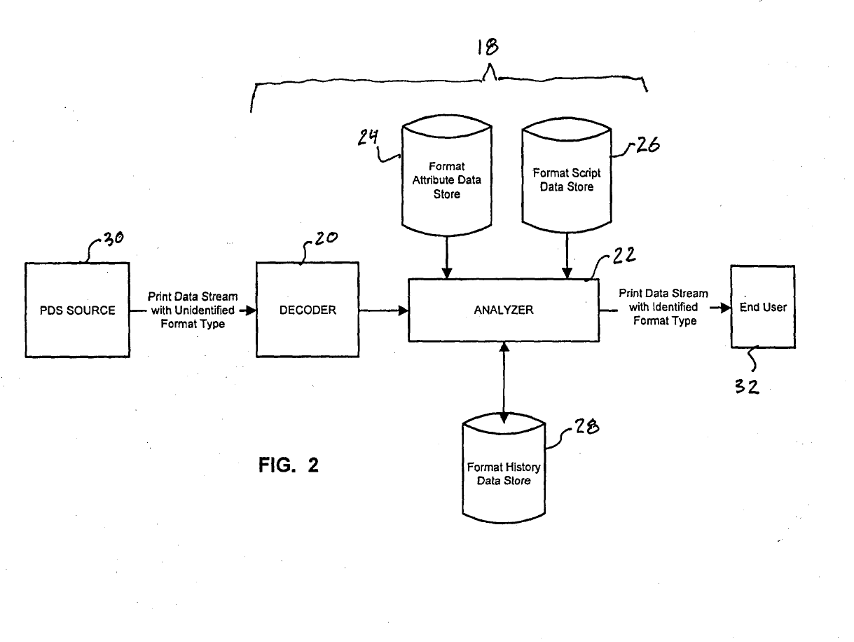

An exemplary embodiment of a computer-implemented system 18 for determining the format type of a print data stream is depicted in FIG. 2. The computer-implemented system 18 is comprised generally of a decoder 20, an analyzer 22, a format attribute data store 24, a format script data store 26, and a format history data store 28. It is to be understood that only the primary components of the system are discussed herein, but that other software-implemented components may be needed to control and manage the overall operation of the system.

In operation, the decoder 20 is adapted to receive a print data stream having an unknown format type. The print data stream is typically received from a mainframe computer, however, it is readily understood that the print data stream may also be received from other types of data stream sources 30. In one exemplary embodiment, the print data stream preferably includes an identifier for its source which is embedded in the print data stream and readable by the system. As will be further described below, the decoder 20 determines an encoding format for the print data stream.

The analyzer 22 is adapted to receive the identified encoding format, along with the print data stream, from the decoder 20. The analyzer 22 is generally operable to determine the format type of the print data stream. In particular, the analyzer 22 compares the print data stream to attributes of known print stream data formats which are stored in the format attribute data store 24. Thus, the format attribute data store 24 contains attribute data for a plurality of known format types. For example, format attribute data may include record length information, carriage control information, content marker information, as well as any other information that may define a format type. As further described below, the analyzer 22 may also access the format script data store 26. The format script data store 26 contains a plurality of custom scripts that can be individually retrieved by the analyzer 22 to test the unidentified print data stream.

Once a format type has been identified for the print data stream, the analyzer 22 updates the format history data store 28. The format history data store 28 contains records for print data streams that have been previously identified by the system, where each record preferably includes a unique identifier for the print data stream, an identifier for the source of the print data stream and an identifier for the format type that has been determined for the print data stream. The print data stream, including a format type identifier, is then sent to an end user 32. It is envisioned that the end user 32 may include a printer, a data store, another computing device or various other destinations.

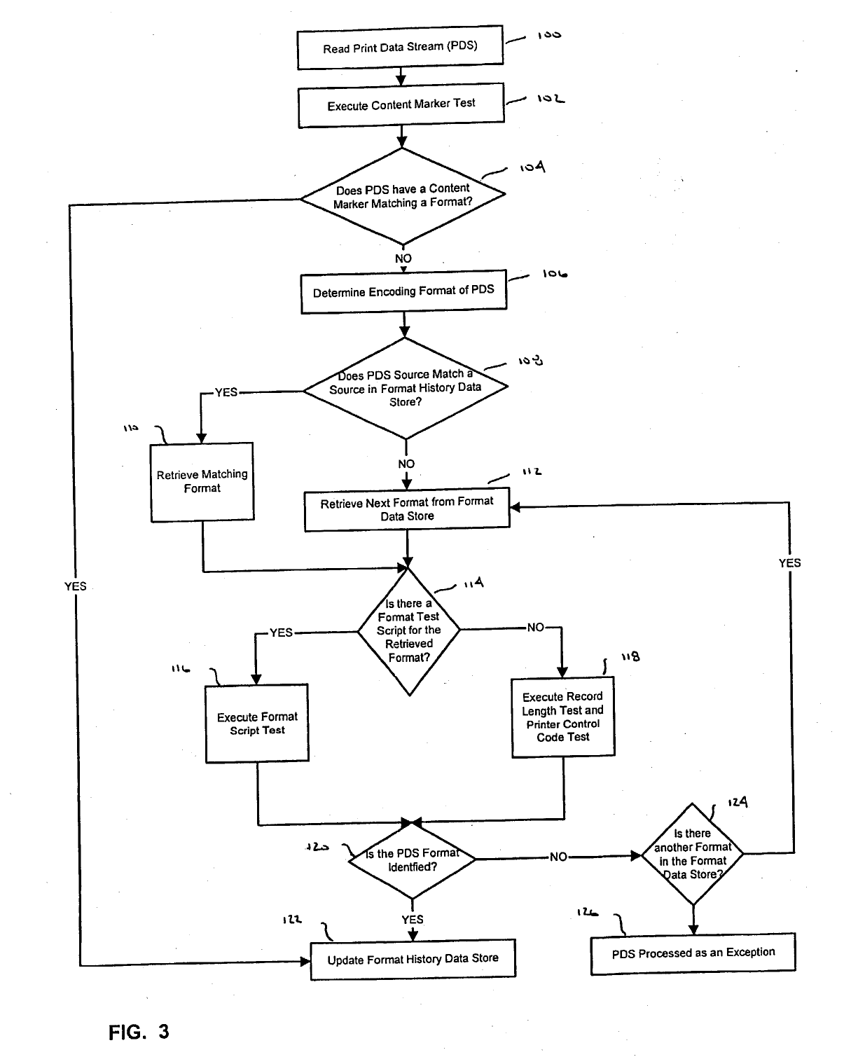

A more detailed description of an exemplary embodiment for determining a format type of a print data stream is further described in relation to FIG. 3. Beginning at step 100, a print data stream having an unknown format type is read by the decoder 20. The print data stream must be of a sufficient size to allow line lengths and page breaks to be accurately analyzed, for example two pages of print stream data.

First, the decoder 20 determines at step 102 if the print data stream includes a unique content marker that matches the content marker of a known format type. A content marker is typically a unique identifier embedded at the beginning of a print stream which is indicative of a well defined format type. However, it is readily understood that a content marker may be located anywhere within a print data stream. The decoder 20 retrieves those formats from the format attribute data store 24 having unique content markers and then compares the content marker(s) for each of the retrieved formats against the print data stream. For example, a string of hexadecimal values of “0x76 0x1A 0xFF 0xFF” located within a print data stream is indicative of a Barr S/370 with word-length records format type. A successful match of content markers identifies the format type for the print data stream, and processing continues at step 122.

If there is not a successful match of content markers, the decoder 20 determines an encoding format for the print data stream at step 106. For instance, the numeric values of the print data stream may be analyzed to determine if the print data stream is encoded in an EBCDIC or ASCII encoding format. In one exemplary embodiment, the encoding format is determined based on the frequency of letters and/or spaces within the print data stream, where the frequency of letters and spaces within the print data stream are ascertained from EBCDIC and ASCII frequency tables. For example, the letter “E” is the most common letter in the US-English language, and has the hexadecimal value of “1xC5” in EBCDIC encoding and has the hexadecimal value of “0x45” in ASCII encoding. Therefore, a high frequency of either hexadecimal value would indicate the particular encoding set associated with the value. Alternatively, the decoder 20 can look for unique encoding identifiers. In the EBCDIC encoding format, the numbers “0” through “9” are encoded as hexadecimal values “F0” through “F9”. There are no meaningful character values for hexadecimal values “F0” through “F9” in the ASCII encoding set and therefore even a low frequency of hexadecimal values for “F0” through “F9” would indicate EBCDIC character encoding. If less than half of the characters in the print data stream cannot be assigned to EBCDIC, ASCII, or any other encoding format, the data is processed as binary data. As discussed below, the encoding format will be used to retrieve only those formats having the identified encoding format, thereby increasing the efficiency of the preferred embodiment. While the above description has been provided with reference EBCDIC and ASCII encoding formats, it is readily understood that other types of encoding formats are also within the scope of the present invention.

Prior to retrieving attribute data for any given format, the analyzer 22 will first determine if it has previously processed a print data stream from the same source. To do so, the analyzer 22 compares a source identifier embedded in the print data stream at step 108 with other source identifiers from previously identified formats as stored in the format history data store 28. If the source identifier of the print data stream matches a source identifier in the format history data store 28, the corresponding format type is also is retrieved from the format history data store 28. At step 110, the format type is then used to retrieve attribute data from the format attribute data store 24. Attribute data for this format type will serve as the starting point for assessing the print data stream. The underlying premise for this processing is that a given source often employs the same format type for each data stream. If so, the analyzer 22 is able to more quickly identify the format type of the print data stream.

When there is not a match for the embedded source identifier, the analyzer 22 proceeds to analyze the print data stream in relation to each of the known data stream formats until a match is found. As a starting point, the analyzer 22 may begin by retrieving attribute data for the most recently identified format type in step 112. In addition, the analyzer preferably retrieves attribute data only for format types having the encoding format determined in step 104. However, it is readily understood that other retrieval approaches are also within the scope of the present invention.

Analysis is performed by running a series of tests against the print data stream. In some instances, the analyzer 22 may employ format test scripts to determine the format type of the print data stream. Format test scripts are one or more custom algorithms for testing complicated, well-defined formats not easily identified by other methods. Thus, the retrieved format record from the format attribute data store will include one or more references to format test scripts. In this case, the analyzer 22 individually retrieves each format test script from the format script data store 26 and executes the format test script in relation to the print data stream as shown at step 116. If the print data stream passes each format test script, the print data stream format type is identified and processing continues at step 122; otherwise, the next known format record is retrieved until a match is found or all of the known formats have been applied to the print data stream.

In the exemplary embodiment, the analyzer 22 alternatively employs a record length test and a printer control code test to determine the format type as shown at step 118. A given print data stream typically includes data organized into a plurality of records having either fixed or variable record lengths. In either case, the analyzer 22 uses record length attribute data to evaluate the print data stream. For a print data stream having fixed record lengths, the print data stream may be tested by determining if the size of the print data stream is evenly divisible by the size of the fixed record length. For a print data stream having variable record lengths, the print data stream may be tested by determining if it is possible to move from record to record within the print data stream using the predefined range of record lengths. Specifically, each record in the print data stream must fall within the minimum and maximum record length value as defined by the record length attribute data. It is readily understood that control record quantity and lengths will be accounted for in these calculations.

If the record lengths of the print stream data fully match with the record lengths of the retrieved format type, each record is then analyzed to determine if it contains the applicable printer control codes. The position and value of each printer control code in each record of the print data stream is compared to the retrieved format type. If the carriage control codes of the print data stream fully match the carriage control attribute data for the retrieved format type, then the format type of the print data stream is identified and processing continues at step 122; otherwise, another known format record is retrieved at step 112 until a match is found or all of the known formats have been applied to the print data stream. It is readily understood that other types of tests may be suitable for determining the format type of a print data stream, and thus fall within the scope of the present invention.

Once the print data stream format type has been identified, the analyzer 22 updates the format history data store 28 as shown at step 122. A unique identifier for the print data stream, the embedded source identifier, and an identifier for the format type associated with the print data stream are all stored together in the format history data store 28. Using the methodology described above, a print data stream having an unknown format type may be automatically identified. A print data stream having an identified format can then be easily processed for printing, viewing or other subsequent processing.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for determining a format type of a print data stream having one of a plurality of known data stream formats, comprising:
presenting a print data stream having a plurality of numeric values encoding data formulated in an unknown data stream format;
determining an encoding format for the numeric values of the print data stream; and
analyzing the print data stream in relation to the plurality of known data stream formats, thereby determining a format type for the print data stream.

2. The method of claim 1 wherein the step of determining an encoding format further comprises identifying the encoding format based on frequency of a given numeric value in the print data stream.

3. The method of claim 1 wherein the step of analyzing the print data stream further comprises identifying a subset of known data stream formats from the plurality of known data stream formats based on the encoding format, and analyzing the print data stream in relation to the subset of known data stream formats.

4. The method of claim 1 wherein the encoded numeric values of the print data stream are organized into one or more records, such that the step of analyzing the print data stream further comprises identifying the format type of the print data stream based on delimitation between said records.

5. The method of claim 1 wherein the step of analyzing the print data stream further comprises identifying the format type of the print data stream based on printer control codes embedded therein.

6. The method of claim 1 wherein the step of analyzing the print data stream further comprises searching the print data stream for a unique identifier, the identifier being indicative of a known data stream format.

7. The method of claim 1 wherein the presented print data stream includes a source identifier embedded therein, and the step of analyzing the print data stream further comprises selecting one of the plurality of known data stream formats using the source identifier and analyzing print data stream in relation to said one known data stream format.

8. The method of claim 1 wherein the encoding format is at least one of ASCII and EBCDIC.

9. A method for determining a format type of a print data stream having one of a plurality of known data stream formats, comprising:
presenting a print data stream having a plurality of numeric values encoding data formulated in an unknown data stream format, the numeric values being organized into one or more records having printer control codes embedded therein;
determining an encoding format for the numeric values of the print data stream;
identifying a subset of known data stream formats from the plurality of known data stream formats based on the encoding format; and
analyzing the print data stream in relation to the plurality of known data stream formats, thereby determining a format type for the print data stream.

10. The method of claim 9 wherein the step of determining an encoding format further comprises identifying the encoding format based on frequency of a given numeric value in the print data stream.

11. The method of claim 9 wherein the step of analyzing the print data stream further comprises searching the print data stream for characteristics unique to known format types.

12. The method of claim 9 wherein the step of analyzing the print data stream further comprises identifying the format type of the print data stream based on delimitation between said records.

13. The method of claim 9 wherein the step of analyzing the print data stream further comprises identifying the format type of the print data stream based on printer control codes embedded therein.

14. The method of claim 9 wherein the step of analyzing the print data stream further comprises using a script to compare the print data stream to one of the plurality of known data stream format.

15. A computer implemented system for determining a format type of a print data stream comprising:
a format attribute data store for storing attribute data for a plurality of known print data stream formats;
a decoder adapted to receive a print data stream having an unknown format and operable to determine an encoding format for the print data stream; and
an analyzer in data communication with the format attribute data store, the analyzer adapted to receive the print data stream from the decoder and operable for comparing the print data stream to the plurality of known print stream formats in the format attribute data store.

16. The computer implemented system of claim 15 further comprising a format script data store for storing scripts, the analyzer in data communication with the format script data store and operable to use the scripts to identify the format type of the print data stream.

17. The computer implemented system of claim 16 further comprising a format history data store for storing previously identified print data stream formats, the analyzer in data communication with the format history data store and operable to use the previously identified print data stream formats to identify the format type of the print data stream.
